(19) United States
(12) Patent Application Publication
(10) Pub. No.: US 2020/0215923 A1
(43) Pub. Date: Jul. 9, 2020

(54) On-Board Vehicle Battery Charging System and Method

(71) Applicant: Louis Obyo Nelson, Abuja (NG)

(72) Inventor: Louis Obyo Nelson, Abuja (NG)

(21) Appl. No.: 16/540,539

(22) Filed: Aug. 14, 2019

Related U.S. Application Data
(60) Provisional application No. 62/789,207, filed on Jan. 7, 2019.

(51) Int. Cl. B60L 53/00; B60L 8/00; F03D 9/11

(52) U.S. Cl. CPC B60L 53/00; B60L 8/006; B60L 2200/28; B60L 2200/36; B60L 2200/18; F03D 9/11

(57) ABSTRACT

An on-board vehicle battery charging system and method. The system includes a vehicle with a wind turbine operably attached thereto and configured to charge a battery of the vehicle. The wind turbine is configured to rotate with a wind or an airflow, for example, when the vehicle is in motion. A shaft of the wind turbine is operably connected to an electric generator configured to generate an electrical charge upon a rotation of the shaft, thereby charging the battery of the vehicle and extending an operating range of the vehicle.

### CROSS REFERENCE TO RELATED APPLICATIONS

This application claims priority under 35 U.S.C. § 119(e) to U.S. Provisional Application No. 62/789,207 filed on Jan. 7, 2019. The above identified patent application is incorporated by reference herein in its entirety to provide continuity of disclosure.

### BACKGROUND OF THE INVENTION

The present invention relates to a system and method for utilizing wind and/or air flow to directly charge or recharge a battery of a vehicle, such as an electric vehicle.

Increasingly, many vehicles are powered by electricity. Electric vehicles provide cleaner transportation that does not produce substantial gaseous waste product, such as exhaust; however, because vehicle battery technologies are still evolving, the operative range of electric vehicles is lower than desired, and the charge time is longer than desired. It is desirable that these vehicles have a longer operative range, thereby requiring fewer stops to recharge the battery or batteries that power these vehicles. Achieving this result may require a source of energy that is reliable and renewable.

Therefore, there is a need for a system and method for utilizing wind and/or air flow to directly charge or recharge a battery of a vehicle, such as an electric vehicle. The present invention addresses this unmet need.

Devices have been disclosed in the art that relate to vehicles and wind turbines. These include devices that have been patented and published in patent application publications. These devices are often unable to effectively charge or recharge a battery of a vehicle, such as an electric vehicle. In view of the devices disclosed in the art, it is submitted that there is a need in the art for an improvement to existing systems and methods for charging or recharging batteries of electric vehicles. In view of the present disclosure, it is submitted that the present invention substantially diverges in structural and functional elements from devices in the art, and the present invention substantially fulfills an unmet need in the art.

### SUMMARY OF THE INVENTION

In view of the disadvantages inherent in the known types of systems and methods for charging or recharging vehicle batteries in the art, the present invention provides a new and improved on-board vehicle battery charging system, wherein the same can be utilized in a method for charging or recharging one or more batteries of a vehicle, such as an electric vehicle.

It is therefore an object of the present invention to provide a system and method for charging a battery of a vehicle.

In one aspect, the system comprises a wind turbine attached to a rearward portion of a vehicle, and an electric generator of the vehicle and operably connected to a shaft of the wind turbine and a battery of the vehicle. Upon a rotation of a plurality of blades of the wind turbine, the shaft of the wind turbine rotates to generate electricity via the electric generator, such that the electricity is stored in the battery of the vehicle. The system may be utilized when the vehicle is in motion (i.e., forward or backward, driving or coasting), and accordingly, in some embodiments, the plurality of blades is configured to rotate either clockwise or counterclockwise and generate and store electricity based on the rotation in either direction. It may be particularly desirable to utilize the system when performing a coasting operation and/or a braking operation, as described elsewhere herein.

In another aspect, the method comprises attaching a wind turbine to a rearward portion of a vehicle, operably connecting a shaft of the wind turbine and the battery of the vehicle to an electric generator of the vehicle, and rotating a plurality of blades of the wind turbine to rotate the shaft of the wind turbine and generate electricity via the electric generator, such that the electricity is stored in the battery of the vehicle. Generally, the method may include the installation and use of the system with the vehicle, or it may include use of the system with the vehicle. In various embodiments, the method may further comprise monitoring a status of the battery of the vehicle, such that the monitoring may assist one or more vehicle operators with deciding whether to engage the system to recharge the battery. For example, if the monitoring step reveals the battery needs recharging, this may prompt the operator(s) to initiate use of the system to recharge the battery. Accordingly, it is envisioned that the method may include a monitoring step at any point during performance of the method, including as a first step, as an intermediate step, and/or as a last step. Likewise, it is envisioned that the method may be performed once and/or a plurality of times, such that the operator(s) can repeatedly recharge the battery of the vehicle while driving, according to need.

In some embodiments, the vehicle is powered by the battery and does not include an internal combustion engine. Because electric vehicles may have a limited operative range, this may be a particularly exemplary embodiment. In such embodiments, the vehicle may be powered by one battery or a plurality of batteries, according to a design or manufacture of the vehicle. Accordingly, it is envisioned that in various embodiments, “battery” may refer to a single battery, or it may refer to a plurality of batteries, based on the particular embodiment at hand. However, in all embodiments in which the vehicle is powered by the one or more batteries and does not include the internal combustion engine, the vehicle may be referred to as an “electric vehicle” because the energy utilized to transport the vehicle is electricity.

In some embodiments, it may be desirable to utilize the system for a method that comprises a coasting operation and/or a braking operation. A “coasting operation” may refer to a motion of the vehicle that may occur with minimal or no energy required from an energy source of the vehicle, such as the one or more batteries. Coasting operations may be performed when rolling the vehicle down a hill, whereby the force of gravity pushes the vehicle down the hill and creates an airflow across the vehicle that rotates the plurality of blades to generate electricity. In this manner, coasting operations may provide a particular benefit and a net positive energy at the conclusion of the coasting operation. A similar principle applies to a “braking operation” which may refer to a motion of the vehicle that may occur with minimal or no energy required from the energy source of the vehicle, but is intended to slow or gradually slow a speed of the vehicle. A braking operation may occur on a hill or on a relatively flat terrain. In various embodiments, a portion of the energy expended to accelerate the vehicle from rest to a cruising speed may be recaptured and stored in the one or more batteries upon performing the coasting operation and/or the braking operation.

In some embodiments, the vehicle is selected from a group including but not necessarily limited to a truck, a bus, and a tractor trailer. Because it may be desirable to mount the wind turbine to the rearward portion of the vehicle, the exact nature and structure of the rearward portion of the vehicle may vary according to the vehicle being utilized in a particular embodiment. For example, in embodiments having a truck or a tractor trailer with the system installed thereto, the wind turbine may be installed to a cabin of the truck or the tractor trailer; similarly, in embodiments having a bus with the system installed thereto, the wind turbine may be installed to a rear exterior wall of the bus.

In some embodiments, the rotation of the plurality of blades of the wind turbine occurs as a result of a forward motion of the vehicle. Because many vehicles spend a majority of their operating time moving in a forward direction or a forward motion, the rotation of the plurality of blades of the wind turbine may be configured to particularly capture the airflow that results from the forward motion of the vehicle.

In some embodiments, the forward motion includes a coasting operation of the vehicle, wherein the coasting operation produces more electricity than is consumed. Generally, a coasting operation may include coasting the vehicle down a hill or coasting the vehicle as part of a braking operation, which may occur on a hill or on a relatively flat terrain. However, it is envisioned that to charge or recharge one or more batteries of the vehicle, the coasting operation produces more electricity than it requires or consumes. In this manner, a net positive production of electricity is produced and the one or more batteries are effectively recharged.

Another object of the present invention is to provide a system that may be readily manufactured from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of the invention will be particularly pointed out in the claims, the invention itself and manners in which it may be made and used may be better understood after a review of the following description, taken in connection with the accompanying drawings, wherein like numeral annotations are provided throughout.

FIG. 1 depicts a perspective view of an exemplary on-board vehicle battery charging system, installed to a rearward portion of a tractor trailer.

FIG. 2 depicts an exemplary motion of a plurality of blades of a wind turbine of the exemplary system.

FIG. 3 depicts a close-up perspective view of the plurality of blades and an operative connection between the wind turbine and a generator of the tractor trailer.

### DETAILED DESCRIPTION OF THE INVENTION

Reference is made herein to the attached drawings. Like reference numerals are used throughout the drawings to depict like or similar elements of the invention. The figures are intended for representative purposes only and should not be considered limiting in any respect.

Reference is now made to the drawings, which depict one or more exemplary embodiments of the invention.

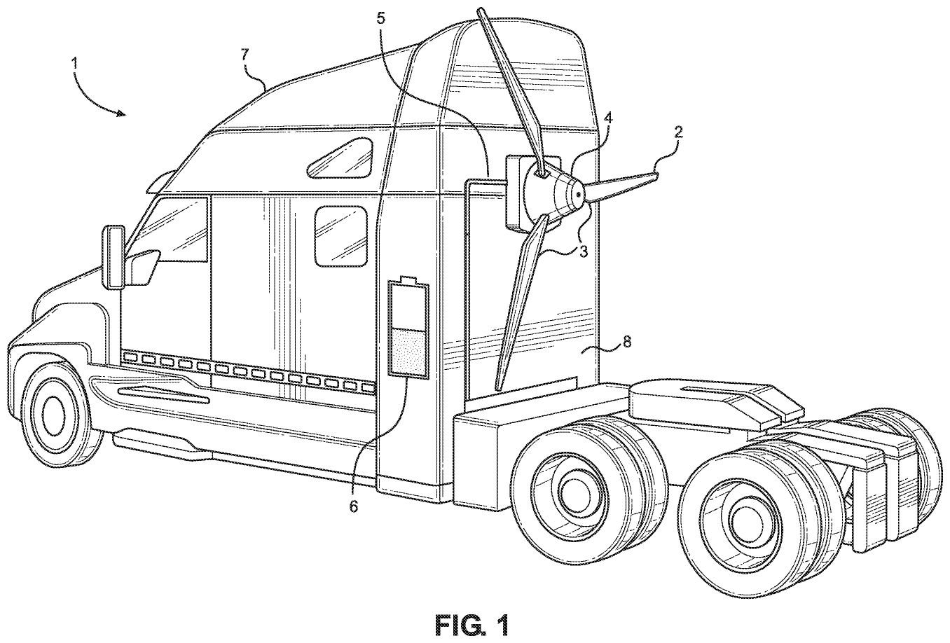

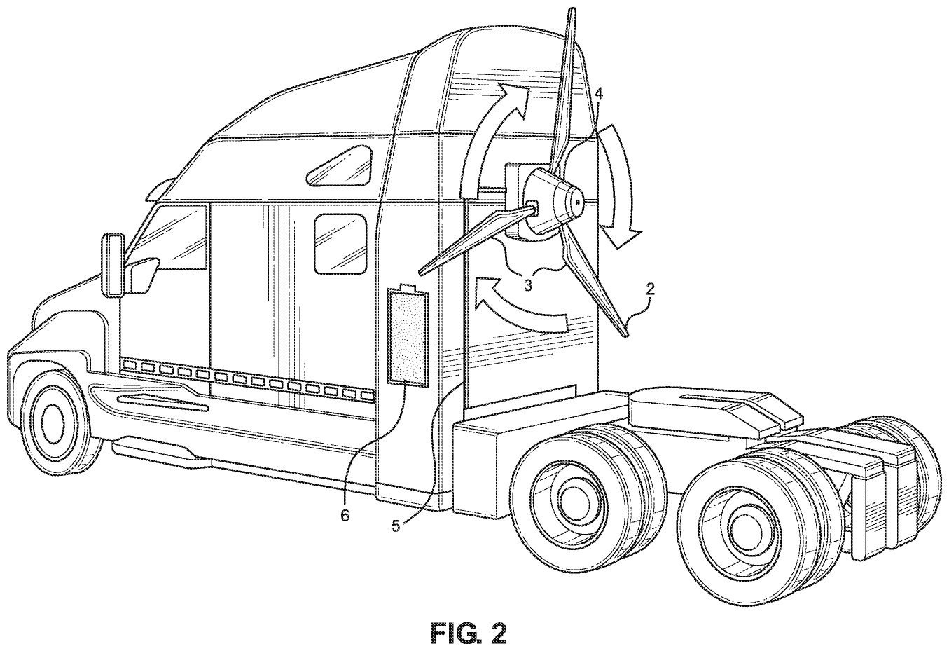

Referring now to FIGS. 1 and 2, there are depicted a perspective view of an exemplary on-board vehicle battery charging system, installed to a rearward portion of a tractor trailer (FIG. 1), and an exemplary motion of a plurality of blades of a wind turbine of the exemplary system (FIG. 2). The on-board vehicle battery charging system 1 includes a wind turbine 2 attached to a rearward portion 8 of a vehicle 7. An electric generator may be disposed within the vehicle 7 and is operably connected, by way of an operable connection 5, to a shaft 4 of the wind turbine 2 and a battery 6 of the vehicle 7.

Upon a rotation of a plurality of blades 3 of the wind turbine 2 (see FIG. 2), the shaft 4 of the wind turbine 2 rotates to generate electricity via the electric generator, such that the electricity is stored in the battery 6 of the vehicle 7. In various embodiments, the plurality of blades 3 is configured to rotate either clockwise or counterclockwise and generate and store electricity based on the rotation in either direction. In this manner, the system 1 may be configured to generate and store electricity if the vehicle 7 is at rest and/or if the vehicle 7 is in motion. If the vehicle 7 is at rest, a wind of an environment containing the system may cause the plurality of blades 3 to rotate. If the vehicle 7 is in motion, the wind of the environment and/or an airflow caused by the motion of the vehicle 7 may cause the plurality of blades 3 to rotate. In this manner, one or more sources of wind and/or airflow may be utilized when the vehicle is at rest or in motion to generate and store electricity via the system 1.

In some embodiments, the vehicle 7 is powered by the battery 6 and does not include an internal combustion engine. Accordingly, the vehicle 7 may be an electric vehicle. In such embodiments, the system and method of the present invention may be utilized to continuously or intermittently recharge one or more batteries 6 of the vehicle, and effectively extend an operative range of the vehicle 7. The system 1 may be utilized as part of a method comprising a coasting operation, a braking operation, or both the coasting operation and the braking operation. In some embodiments, the system 1 may be utilized as part of a method comprising another vehicle operation that can generate electricity via the wind turbine 2. In some embodiments, a motion of the vehicle 7 is active and requires energy from an energy source of the vehicle 7 to propel the vehicle 7 forward or rearward. In other embodiments, the motion of the vehicle 7 is passive and does not require energy from the energy source of the vehicle 7 to propel the vehicle 7 forward or rearward.

Generally, the method of the present invention may comprise attaching a wind turbine 2 to a rearward portion 8 of a vehicle 7, operably connecting a shaft 4 of the wind turbine 2 and a battery 6 of the vehicle 7 to an electric generator of the vehicle 7, and rotating a plurality of blades 3 of the wind turbine 2 to rotate the shaft 4 of the wind turbine 2 and generate electricity via the electric generator, such that the electricity is stored in the battery 6 of the vehicle 7. The method may be utilized to charge and/or recharge the battery 6 of the vehicle 7. In some embodiments, the method comprises a coasting operation. In some embodiments, the method comprises a braking operation. In some embodiments, the method comprises both the coasting operation and the braking operation. In various embodiments, a portion of the energy expended to accelerate the vehicle 7 from rest to a cruising speed may be recaptured and stored in one or more batteries 6 upon performing the coasting operation and/or the braking operation. In this manner, it is generally envisioned that the systems and methods of the present invention produce a net positive energy output, whereby the energy produced is stored within the one or more batteries 6 of the vehicle 7.

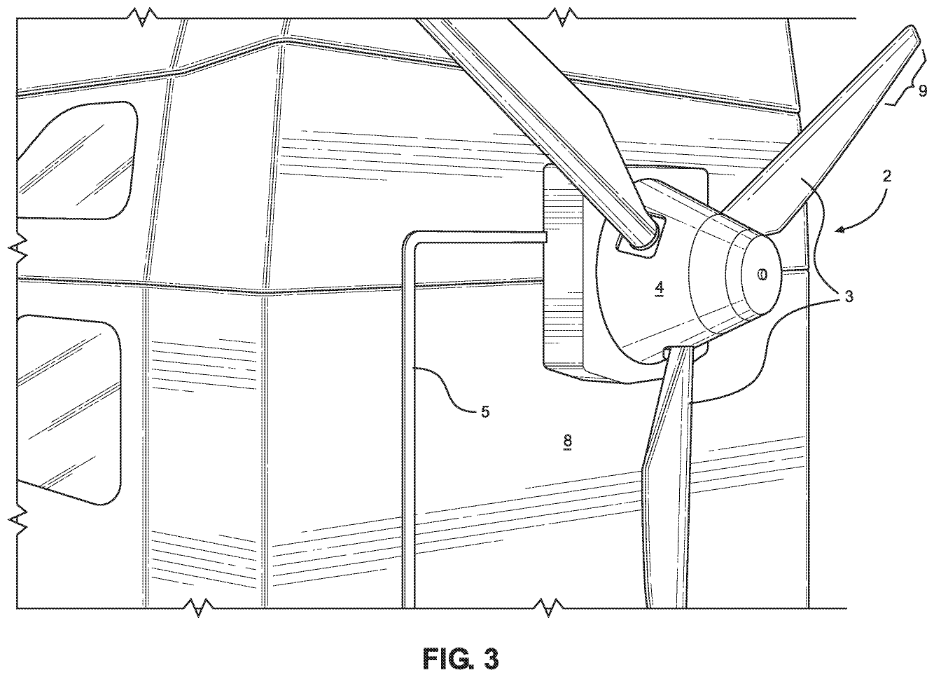

Referring now to FIG. 3, there is depicted a close-up perspective view of the plurality of blades and an operative connection between the wind turbine and a generator of the tractor trailer. The wind turbine 2 includes the plurality of blades 3 that extend radially outward from the shaft 4 of the wind turbine 2. In the shown embodiment, an outer portion 9 of the blades of the plurality of blades 3 may extend beyond an outer edge of the vehicle. In this manner, a diameter of a circle encompassed by the plurality of blades may be larger than a width, a height, or another measurement of the rearward portion 8 of the vehicle.

In the shown embodiment, the wind turbine 2 is operably connected to the battery of the vehicle by way of the operable connection 5. Operable connection 5 may include any suitable connection configured to transmit electricity from the generator to the battery. In this manner, the electricity may be transmitted to and stored within the one or more batteries of the vehicle, so as to charge and/or recharge the one or more batteries of the vehicle using the system. In this manner, the one or more batteries may be continued to be utilized for an activity, such as propelling the vehicle in a forward direction and/or a rearward direction.

The foregoing descriptions of specific embodiments of the present invention have been presented for purposes of illustration and description. They are not intended to be exhaustive or to limit the present invention to the precise forms disclosed, and modifications and variations are possible in view of the above teaching. The exemplary embodiment was chosen and described to best explain the principles of the present invention and its practical application, to thereby enable others skilled in the art to best utilize the present invention and its embodiments with modifications as suited to the use contemplated.

It is therefore submitted that the present invention has been shown and described in the most practical and exemplary embodiments. It should be recognized that departures may be made which fall within the scope of the invention. With respect to the description provided herein, it is submitted that the optimal features of the invention include variations in size, materials, shape, form, function and manner of operation, assembly, and use. All structures, functions, and relationships equivalent or essentially equivalent to those disclosed are intended to be encompassed by the present invention.

I claim:

1) An on-board vehicle battery charging system, comprising:
a wind turbine attached to a rearward portion of a vehicle;
an electric generator disposed within the vehicle and operably connected to a shaft of the wind turbine and a battery of the vehicle;
whereupon a rotation of a plurality of blades of the wind turbine, the shaft of the wind turbine rotates to generate electricity via the electric generator, wherein the electricity is stored in the battery of the vehicle.

2) The system of claim 1, wherein the vehicle is powered by the battery and does not include an internal combustion engine.

3) The system of claim 1, wherein the vehicle is selected from a group consisting of: a truck, a bus, and a tractor trailer.

4) The system of claim 1, wherein an outer portion of the blades of the plurality of blades extends beyond an outer edge of the vehicle.

5) The system of claim 1, wherein the rotation of the plurality of blades of the wind turbine occurs as a result of a forward motion of the vehicle.

6) The system of claim 5, wherein the forward motion includes a coasting operation of the vehicle.

7) A method for charging a battery of a vehicle, comprising:
attaching a wind turbine to a rearward portion of a vehicle;
operably connecting a shaft of the wind turbine and the battery of the vehicle to an electric generator disposed within the vehicle;
rotating a plurality of blades of the wind turbine to rotate the shaft of the wind turbine and generate electricity via the electric generator, wherein the electricity is stored in the battery of the vehicle.

8) The method of claim 7, wherein the vehicle is powered by the battery and does not include an internal combustion engine.

9) The method of claim 7, wherein the vehicle is selected from a group consisting of: a truck, a bus, and a tractor trailer.

10) The method of claim 7, wherein an outer portion of the blades of the plurality of blades extends beyond an outer edge of the vehicle.

11) The method of claim 7, wherein the rotation of the plurality of blades of the wind turbine occurs as a result of a forward motion of the vehicle.

12) The method of claim 11, wherein the forward motion includes a coasting operation of the vehicle.
